(19) United States
(12) Patent Application Publication
(10) Pub. No.: US 2015/0335924 A1
(43) Pub. Date: Nov. 26, 2015

(54) SAFETY DEVICE FOR CLIMBERS

(71) Applicant: VR-TEC GMBH, Bietigheim-Bissingen (DE)

(72) Inventors: MATTHIAS FUCHS, MAGSTADT (DE); ULRICH KOWATSCH, LEONBERG (DE)

(21) Appl. No.: 14/651,736

(22) PCT Filed: Dec. 14, 2012
(86) PCT No.: PCT/EP2012/075501

§ 371 Date: Jun. 12, 2015

(51) Int. Cl. A62B 35/00; A63B 29/00

(52) U.S. Cl. CPC A62B 35/0093; A63B 29/00

(57) ABSTRACT

A safety or braking device, especially for climbers, with a casing (11) containing a rotatable-mounted pulley (12) for a rope (13) and a guide (14) forcing the rope (13) to wrap around the pulley (12) with a shaft (19) of the pulley (12) connected to a centrifugal brake (15), wherein a brake drum (16) of the centrifugal brake (15) is pivotally mounted to the casing (11) and swivels when the rotational speed of the shaft (19) of the pulley (12) exceeds a critical value and forces a pressing element (17) connected to the brake drum (16) against the rope (13), thereby clamping the rope (13) between the pressing element (17) and the guide (14).

The inventions relates to a safety or braking device, especially for climbers, with a casing containing a rotatable-mounted pulley for a rope and a guide forcing the rope to wrap around the pulley with a shaft of the pulley connected to a centrifugal brake.

Safety devices for climbers are already known. They are used in high-rope courses, climbing gyms or in high buildings as a rappelling device in case of fire. Some of the known devices brake a falling load such as a climber only by friction between the rope and a casing. Others have eddy brakes or centrifugal brakes that are more reliable and can safely brake loads of different weights. If the device allows both rappelling and also climbing up towards the device, the rope connected to the climber must slide easily through the device. Rope loops between the climber and the device must be avoided in order to immediately brake the fall of a climber and not only after a certain distance of the fall. Therefore some of the known devices have take-up options. However these take-up options are not only expensive but can also easily be damaged.

It is an objective of the present invention to provide a safety device for climbers which is robust and reliably brakes loads of different weights. A further objective of the invention is to provide a safety device that also allows climbing up towards the device without losing its braking capability during emergencies.

These objectives are achieved by a safety or braking device, especially for climbers, with a casing containing a rotatable-mounted pulley for a rope and a guide forcing the rope to wrap around the pulley, with a shaft of the pulley connected to a centrifugal brake, that is characterized in that a brake drum of the centrifugal brake is pivotally mounted to that casing and swivels when the rotational speed of the shaft of the pulley exceeds a critical value and forces a pressing element connected to the brake drum against the rope, thereby clamping the rope between the pressing element and the guide.

When the centrifugal brake is not active the rope can easily move through the device assisted by the rotation of the pulley. The rope fastened to a climber will therefore not form loops before entering the device when the climber is climbing up towards the device. The device also allows climbing down in a low speed without braking this downward movement. Only when the climber falls—unintentionally or intentionally—will the rotational speed of the pulley shaft exceed the critical value, thereby activating the centrifugal brake. The braking force of the centrifugal brake is assisted by the clamping of the rope between the pressing element and the guide. The pressing element safely guides the rope to the pulley and prevents the rope from slipping over the pulley, thereby ensuring the effective braking of the rope by the centrifugal brake. The clamping of the rope by the pressing element is caused by the brake drum to which the pressing element is connected. The brake drum swivels as soon as the critical speed of the shaft is exceeded. When the speed is lowered again the brake drum swivels back and the rope can move freely through the device again.

Preferably the pressing element is clamping the rope such that the higher the braking force of the centrifugal brake the more the rope is pressed against the surface of the pulley. Thus the rope is always moving synchronously with the pulley.

In a preferred embodiment of the invention the brake drum swivels, driven by the torque of the pulley shaft, as soon as the flyweights of the centrifugal brake come into contact with the brake drum. This feature guarantees that the additional frictional braking force and the safe guidance of the rope are available simultaneously with the braking force of the centrifugal brake. For this purpose the brake drum can be mounted using ball bearings.

It is further advantageous when the pressing element is extending between the two sections of the rope leaving the pulley. In the inactive position of the pressing element the rope can frictionless pass it on both sides. When, however, the centrifugal brake is active and the pressing element is swiveled by the brake drum, the rope section entering the device is clamped between the pressing element and the guide and therefore a high frictional force is applied to the rope and the rope is guided safely to the pulley.

A first end of the rope can be fastened to a climber while a force is applied to the section of the rope that leaves the device on the other side of the pulley, thus holding the rope under tension when the climber is moving towards the device. The force applied to the part of the rope leaving the device prevents the rope from forming loops between the climber and the device and from getting stuck between the pulley and the guide when entering the device. Therefore, the device does not lose its braking abilities while the climber is climbing up. The force applied to the leaving part of the rope can be caused only by the weight of the rope. In a preferred embodiment of the device, however, the force is caused by a counter-weight hanging on the rope section leaving the device. The counter-weight should exceed the weight of the rope between the climber and the device. Therefore the counter-weight should exceed the weight of the total rope in order to be able to always hold the rope entering the device under tension.

In a further preferred embodiment the casing of the device has a lateral extension to which the second end of the rope can be fastened. Then the rope section leaving the device is not hanging straight down, hindering the climber while climbing up. If the device has a counter-weight this counter-weight can be slide-mounted to that rope section extending between the fastening point of the second end of the rope and the pulley.

In a preferred embodiment of the device the guide forces the rope to wrap around the pulley at an angle of at least 90° to make sure that the centrifugal brake can effectively brake the movement of the rope.

A preferred example embodiment of a safety or braking device according to the invention is explained in the following in greater detail with reference to the drawings.

They show:

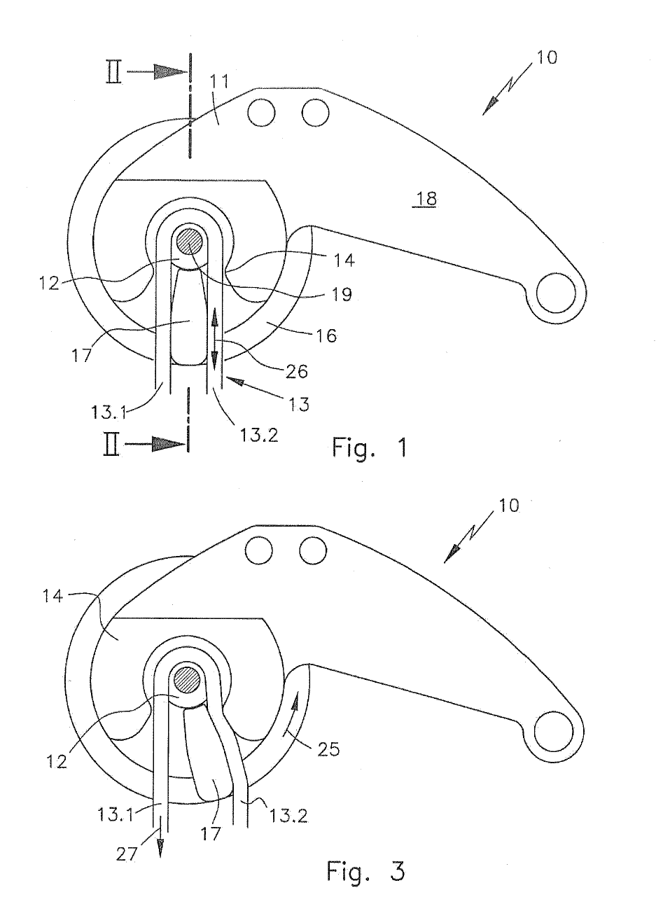

FIG. 1 a front view of a safety device with inactive brake;

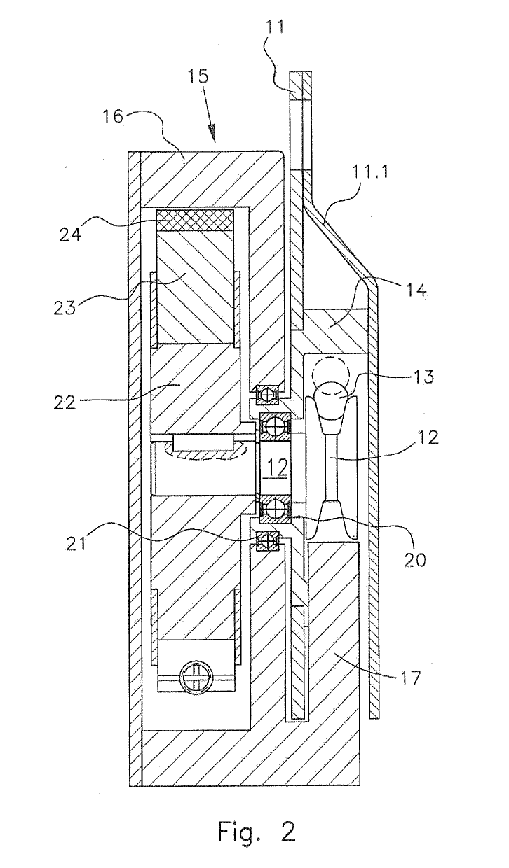

FIG. 2 a cross sectional view of the device of FIG. 1 along the line II-II;

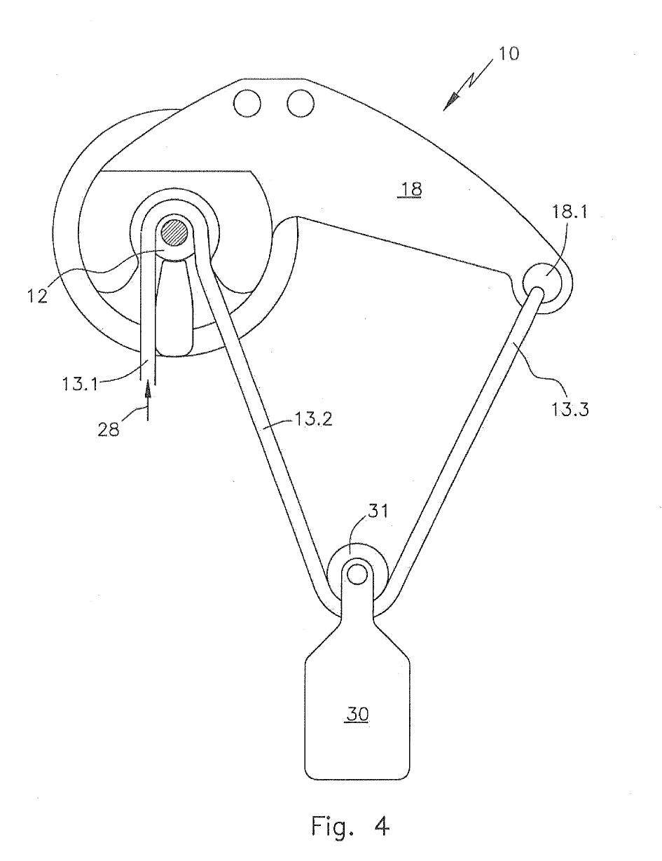

FIG. 3 a front view of the device of FIG. 1 with active brake;

FIG. 4 a front view of the device of FIG. 1 with a counter-weight.

The safety device 10 in FIG. 1 has a casing 11 shown with open cover 11.1 (FIG. 2) and contains a pulley 12 for a rope 13. Further a guide 14 is mounted in the casing 11 that forces the rope 13 to wrap around the pulley 12 at an angle larger than 90°. Also a centrifugal brake 15 (s. FIG. 2) is mounted to the casing 11 of which a brake drum 16 is visible in FIG. 1. With the brake drum 16 that is pivotally mounted around the shaft 19 of the pulley 12 a pressing element 17 is connected and pivotable together with the brake drum 16. The pressing element 17 is extending between the device entering part 13.1 and the device leaving part 13.2 of the rope 13. To the end of the entering part 13.1 a climber can be connected. In FIG. 1 the pressing element 17 is shown in its inactive position in which the rope 13 can freely pass between the pressing element 17 and the guide 14 in both directions of the arrow 26. Therefore a climbing up and a slow climbing down by a climber will not be hindered.

The casing 11 is also provided with a lateral extension 18 the function of which will be described with reference to FIG. 4 below.

FIG. 2 shows an enlarged cross sectional view of the device 10 of FIG. 1. From that view it can be seen that the shaft 19 of the pulley 12 and the brake drum 16 are mounted using ball bearings 20 and 21. The centrifugal brake 15 connected to shaft 19 of the pulley 12 has a central portion 22 with radially movable flyweights 23. The outer surface of the flyweights 23 is covered by a friction lining 24. As soon as the rotational speed of the shaft 19 exceeds a critical value the flyweights 23 are moved radially outward caused by the centrifugal force. The friction lining 24 comes into contact with the inner surface of the brake drum 16 and causes a swiveling of that brake drum 16 in direction of arrow 25 in FIG. 3.

Together with the brake drum 16 also the pressing element 17 is swiveled and clamps the rope 13 between itself and the guide 14 as shown in FIG. 3. Therefore the fast movement of the rope 13 in direction of arrow 27 in FIG. 3 is not only braked by the centrifugal brake 15 braking the rotation of the shaft 19 of the pulley 12 but also by a frictional force caused by the pressing element 17. Thus also the falling of heavy weights can be braked safely. The pressing element 17 further safely guides the rope 13 to the pulley 12, thus ensuring that the centrifugal brake 15 can brake the rope 13 effectively.

FIG. 4 shows the purpose of the lateral extension 18 of the casing 11. A second end 13.3 of the rope 13 can be fastened to an opening 18.1 of the lateral extension 18. On the rope section 13.2 between the pulley 12 and the opening 18.1 a counter-weight 30 can be slide-mounted by a roller 31. If a climber connected to the first end of the rope 13 at the end of section 13.1 is climbing up towards the device 10 the counter-weight 30 forces the rope 13 to move in direction of arrow 28 into and through the device 10 and therefore prevents the rope 13 from forming loops before entering the device 10.

1. Safety or braking device, especially for climbers, with a casing (11) containing a rotatable-mounted pulley (12) for a rope (13) and a guide (14) forcing the rope (13) to wrap around the pulley (12), with a shaft (19) of the pulley (12) connected to a centrifugal brake (15), characterized in that a brake drum (16) of the centrifugal brake (15) is pivotally mounted to the casing (11) and swivels when the rotational speed of the shaft (19) of the pulley (12) exceeds a critical value and forces a pressing element (17) connected to the brake drum (16) against the rope (13), thereby clamping the rope (13) between the pressing element (17) and the guide (14).

2. Safety or braking device according to claim 1, characterized in that the pressing element (17) is clamping the rope (13) such, that the higher the braking force of the centrifugal brake (15) the more the rope (13) is pressed against the surface of the pulley (12).

3. Safety or braking device according to claim 1, characterized in that that brake drum (16) swivels driven by the torque of that pulley shaft (19) as soon as the flyweights (23) of that centrifugal brake (15) come into contact with that brake drum (16).

4. Safety or braking device according to claim 1, characterized in that that pressing element (17) is extending between the two sections (13.1, 13.2) of that rope (13) entering and leaving that pulley (12).

5. Safety or braking device according to claim 1, characterized in that a first end of that rope (13) can be fastened to a climber while a force is applied to the section (13.2) of the rope (13) that leaves the device (10) on the other side of the pulley (12), thus holding the rope (13) under tension when the climber is moving towards that device (10).

6. Safety or braking device according to claim 5, characterized in that that force is caused by a counter-weight (30) hanging on the rope section (13.2).

7. Safety or braking device according to claim 6, characterized in that that casing (11) has a lateral extension (18) to which a second end (13.3) of the rope (13) is fastened.

8. Safety or braking device according to claim 7, characterized in that that counter-weight (30) is slide-mounted to the rope section (13.2) extending between a fastening point (18.1) of the second end (13.3) of the rope (13) and the pulley (12).

9. Safety or braking device according to claim 1, characterized in that the guide (14) forces the rope (13) to wrap around the pulley (12) at an angle of at least 90°.
